(19) United States
(12) Patent Application Publication
(10) Pub. No.: US 2026/0341056 A1
(43) Pub. Date: Oct. 29, 2026

(54) Image Understanding via Cyclical Image Captioning, Generation, and Evaluation

(71) Applicant: GDM Holding LLC, Mountain View, CA (US)

(72) Inventors: Ramin Mehran, Kirkland, WA (US); Hao Wu, Saratoga, CA (US)

(21) Appl. No.: 19/188,643

(22) Filed: Apr. 24, 2025

(51) Int. Cl. G06V 20/70; G06T 11/00; G06V 10/74

(52) U.S. Cl. CPC G06V 20/70; G06T 11/00; G06V 10/761

(57) ABSTRACT

Provided are systems and methods for performing cyclical image captioning and generation. The approaches can account for captions, initial image conditions, and visual difference texts; and can therefore be referred to as image conditioning generation-based and difference description generation-based machine-learned models. The models can include machine-learned models that generate synthetic images using an initial image, a caption, a synthetic image, and conditioning data.

### FIELD

The present disclosure relates generally to machine learning processes and machine-learned devices and systems. More particularly, the present disclosure relates to improved image understanding via performance of one or more cycles of image captioning, generation, and evaluation.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method may include generating, by a first machine-learned model, a caption that textually describes content in an initial image. The method may also include generating, by a second machine-learned model, a synthetic image based on the caption, where the second machine-learned model is conditioned on conditioning data, the conditioning data may include the initial image or data derived from the initial image. The method may also include comparing, by a third machine-learned model, the synthetic image with the initial image to generate, as a result of the comparing, a description of visual differences between the synthetic image and the initial image. The method may also include refining at least one of the caption and the second machine-learned model based on the description of the visual differences.

Some example implementations may include some or all of the following features. In some implementations, the second machine-learned model may include at least one of a network or a network machine-learned model that includes at least one property to, or that is configured to, recreate the initial image input into the first machine-learned model based on the conditioning data. The conditioning data may include visual structure data extracted from the initial image, the visual structure data may include edge data, depth data, segmentation data, or pose data. Said refining further may include training the second machine-learned model to generate the initial image based on the refined caption. Said refining may include generating, by a fourth machine-learned model, a refined caption based on the description of visual differences between the synthetic image and the initial image. The first machine-learned model and the third machine-learned model may include a same multi-modal model or different multi-modal models.

One general aspect includes the computer-implemented method. Other embodiments of this aspect include corresponding computer systems, apparatus, and computer programs recorded on one or more computer storage devices, each configured to perform the actions of the methods.

Another example aspect is directed to a computing system, the computing system including one or more processors and one or more non-transitory computer-readable media that collectively store instructions that, when executed by the one or more processors, cause the computing system to perform operations. The operations may include processing a first image with a first machine-learned model to generate, as an output of the first machine-learned model, a caption that textually describes content of the first image. The operations may also include processing the caption with a second machine-learned model to generate a second image that depicts content textually described by the caption, where the second machine-learned model is conditioned on conditioning data. The conditioning data may include the first image or data derived from the first image. The operations may also include processing the first image and the second image with a third machine-learned model to generate, as output of the third machine-learned model, visual differences. The operations may also include processing the caption and the visual differences with a fourth machine-learned model to generate, as output of the fourth machine-learned model, a revised caption.

Implementations may include one or more of the following features. The operations may also include processing, as input to the first machine-learned model, a training pair may include the first image and the revised caption to train the first machine-learned model. The operations may also include processing, as input to the second machine-learned model, a training pair may include the first image and the revised caption to train the second machine-learned model. The operations may also include performing a first iterative processing loop. The first iterative processing loop may include processing the first image to generate the caption, the caption may include a first caption; processing the first caption to generate the second image; processing the first image and the second image to generate the visual differences, the visual differences may include first visual differences; and processing the caption and the visual differences to generate the revised caption, the revised caption may include a first revised caption. The operations may also include performing a second iterative processing loop. The second iterative processing loop may include processing the first image to generate a second caption; processing the second caption to generate a third image; processing the first image and the third image to generate second visual differences; and processing the second caption and the second visual differences to generate a second revised caption, the second revised caption having a level of accuracy that is greater than the first revised caption. The operations may also include iteratively performing the operations for a plurality of cycles. The visual differences may include a textual description of visual differences. The first machine-learned model may include a caption generation model. The second machine-learned model may include an image generation model. The third machine-learned model may include a multi-modal model. The fourth machine-learned model may include a large language model (LLM). The first machine-learned model, the third machine-learned model, and the fourth machine-learned model may include a single multi-modal model or multiple different multi-modal models. Implementations of the described techniques may include hardware, a method or process, or computer software on a computer-accessible medium.

One general aspect includes one or more non-transitory computer readable media storing instructions that are executable by one or more processors to perform operations. The operations may include processing a first image with a first machine-learned model to generate, as an output of the first machine-learned model, a caption that textual describes content of the first image. The operations may include processing the caption with a second machine-learned model to generate a second image that depicts content textually described by the caption, where the second machine-learned model is conditioned on conditioning data. The conditioning data may include the first image or data derived from the first image. The operations may include processing the first image and the second image with a third machine-learned model to generate, as output of the third machine-learned model, visual differences. The operations may include processing the caption and the visual differences with a fourth machine-learned model to generate, as output of the fourth machine-learned model, a revised caption.

Implementations may include one or more of the following features. The operations may include processing, as input to the first machine-learned model, a training pair may include the first image and the revised caption to train the machine-learned model. The operations may include processing, as input to the second machine-learned model, a training pair may include the first image and the revised caption to train the second machine-learned model. The first machine-learned model may include a caption generation model. The second machine-learned model may include an image generation model. The third machine-learned model may include a multi-modal model. The fourth machine-learned model may include a large language model (LLM). Implementations of the described techniques may include hardware, a method or process, or computer software on a computer-accessible medium.

### BRIEF DESCRIPTION OF THE DRAWINGS

FIGS. 1A and 1B are block diagrams depicting an example refinement to a caption using a caption, initial image condition, and visual difference text aggregation-based synthetic image comparison according to example embodiments of the present disclosure.

FIGS. 2A and 2B are block diagrams depicting an example refinement to a machine-learned model using a caption, initial image condition, and visual difference text aggregation-based synthetic image comparison according to example embodiments of the present disclosure.

FIG. 3 depicts an example environment for caption, initial image condition, and visual difference text aggregation-based synthetic image-oriented management performed by systems, and performed via methods therewith, according to example embodiments of the present disclosure.

FIG. 4 is a flow chart diagram illustrating an example method for training a machine-learned model according to example implementations of aspects of the present disclosure;

FIG. 5 is a block diagram of an example processing flow for using machine-learned model(s) to process input(s) to generate output(s) according to example implementations of aspects of the present disclosure;

FIG. 6 is a block diagram of an example sequence processing model according to example implementations of aspects of the present disclosure;

FIG. 7 is a block diagram of an example technique for populating an example input sequence for processing by a sequence processing model according to example implementations of aspects of the present disclosure;

FIG. 8 is a block diagram of an example model development platform according to example implementations of aspects of the present disclosure;

FIG. 9 is a block diagram of an example training workflow for training a machine-learned model according to example implementations of aspects of the present disclosure;

FIG. 10 is a block diagram of an inference system for operating one or more machine-learned model(s) to perform inference according to example implementations of aspects of the present disclosure;

FIG. 11 is a block diagram of an example networked computing system according to example implementations of aspects of the present disclosure;

FIG. 12 is a block diagram of an example computing device according to example implementations of aspects of the present disclosure; and

FIG. 13 is a block diagram of an example computing device according to example implementations of aspects of the present disclosure.

### DETAILED DESCRIPTION

Generally, the present disclosure is directed to computer-implemented systems and methods that leverage multiple models to perform cyclical image captioning and generation, ultimately resulting in improved image captioning ability and/or improved image generation ability. In particular, example systems can leverage captions, initial image conditions, and visual difference texts to generate improved descriptions of scenes depicted in images.

In one example system, a caption associated with an initial image can be generated by a first machine-learned model. The caption can include a detailed description of content in the initial image. A synthetic image can be generated by a second machine-learned model (e.g., a generative model) using the caption. The second machine-learned model can be conditioned on condition data (or “conditioning data”) that includes or is derived from the initial image.

The conditioning data can be identified or generated in various ways. For example, the conditioning data can include an image (or “initial image”) input into the first machine-learned model. Alternatively or additionally, the conditioning data can include data derived from the initial image. In some instances, the second machine-learned model can utilize the conditioning data as a condition to generate a synthetic image.

Various types of data can be utilized to condition generation of the synthetic image by the second machine-learned model. The conditioning data can include visual structure data of various types. The visual structure data can be derived from the initial image. For example, the visual structure data can include edge data, depth data, segmentation data, and/or pose data. Thus, in some implementations, the conditioning data can include data derived from the initial image but may not include the entire initial image itself. In these cases, the second machine-learned model can create an image that shares one or more properties (e.g., a semantic property, an image structure property, etc.) with the initial image. Stated differently, by providing the second machine-learned model with some data derived from the initial input image, but not the initial input image itself) the second machine-learned model may have only partial information about the input image and may therefore not be able to exactly recreate the input image, but instead able to create a similar image based on the partial information provided.

The second machine-learned model can include any of various types of machine-learned models, such as an image generation model. In some examples, the second machine-learned model may be capable of recreating, and/or being customized/tailored to recreate, the initial image input into the first machine-learned model based on the conditioning data or can be capable of creating an alternative image that shares one or more properties (e.g., a semantic property, an image structure property, etc.) with the initial image. For instance, the second machine-learned model can include a network and/or machine-learned model that includes one or more properties to, and/or that is configured to, recreate the initial image input into the first machine-learned model and/or create a similar image based on the conditioning data.

The second machine-learned model can include various properties, and/or be configured in various ways, to recreate the initial image that was input into the first machine-learned model (or a similar image) based on the conditioning data. In some examples, the second machine-learned model can include a neural network structure utilized to control one or more diffusion models (e.g., of the second-machine learned model) by adding one or more extra conditions on one or more operations performed by the diffusion model(s). Thus, in some implementations, the second machine-learned model may be an image generation model that is capable of receiving additional conditioning information and generating synthetic imagery that comports with or is otherwise based on the additional conditioning information. For example, such an image generation model may include various architectural components which enable the output of the model to be influenced by the conditioning information. For instance, the second machine-learned model can include cross-attention layer(s), normalization layer(s), pooling layer(s), and/or other layers that enable the intermediate and/or final output values of the model to be a function of the conditioning information. As one specific non-limiting example, the second machine-learned model can include a ControlNet model.

The visual structure data can be utilized to condition the second machine-learned model to generate the synthetic image with a level of accuracy or similarity (e.g., semantic similarity, image structure similarity, etc.) that may be greater than utilizing only the initial image to condition generation of the synthetic image. Generation of some aspects of the synthetic image that may be at least partially incorrect may be avoided by conditioning the generation of the synthetic image on the visual structure data as well as the initial image. Alternatively or additionally, generation of some portions of the synthetic image that may have relatively lower levels of detail, and/or that may have various imperfections, may be avoided by conditioning the generation of the synthetic image on the visual structure data as well as the initial image.

Subsequent generation of additional synthetic images that may improve upon the generation of the synthetic image also can be conditioned on the conditioning data. The subsequent generation of the additional synthetic images can be performed using the visual structure data, along with the initial image, as a condition to the subsequent generation of the additional synthetic images. For example, in some cases, the subsequent generation of the additional synthetic images may be performed based on prompts being received and analyzed along with the synthetic image. However, some aspects of some prompts may possibly be incorrect. In such instances, by conditioning the subsequent generation of the additional synthetic images on the visual structure data, any potential problems, such as incorrect aspects, relatively lower levels of detail, and/or various imperfections, that may otherwise occur as a result of using only the initial image to condition the generation of the additional synthetic images, can be avoided. The potential problems can be avoided by using the visual structure data along with the initial image to condition the subsequent generation of the additional synthetic images.

The synthetic image can be processed by a third machine-learned model. For example, the third machine-learned model, which can include a multi-modal model, can be utilized to generate a visual difference text. The visual difference text can be generated based on a comparison of the initial image with the synthetic image. The visual difference text can describe visual differences between the initial image and the synthetic image.

The caption, and/or one or more of the machine-learned models (e.g., the first, caption-generating model and/or the second, image-generating model) can be refined using the visual difference text. For example, a fourth machine-learned model can generate a refined caption based on the visual difference text. The refined caption can represent an improved caption for the initial image. Specifically, the refined caption can be improved by understanding and accounting for the visual differences that were identified between the initial image and the synthetic image that was generated from the initial caption. Furthermore, optionally, the initial image and the refined caption can be stored and used as a training pair for any of the models described herein.

More particularly, while current image understanding models can generate descriptions of visual content, accuracy and completeness of the generated descriptions are typically limited. Specifically, training machine-learned models to generate descriptions rely on high-quality data sets that are annotated. Creating and annotating the datasets are expensive and time-consuming. These and other challenges in dataset creation pose barriers to developing machine-learned models that are capable of achieving sufficient operation levels. As such, alternative methods are needed for accurately and efficiently developing capable machine-learned models.

The present disclosure provides solutions to these problems by combining together initial image conditioning generation and difference description generation for machine-learned models that generate synthetic images. Generation of a difference description may be performed using an initial image, a caption, a synthetic image, and conditioning data.

More particularly, the present disclosure proposes several architecture options with different modes of operation utilizing captions and images descriptions. These architectures can incorporate data that is output based on the captions being generated utilizing the iterative loop. This enables refining of various aspects of the architectures, including refining of the captions input into the machine-learned models, and/or refining of the machine-learned models performing comparisons to generate the differences.

The conditioning data can be generated based on the initial image, and/or visual structure data derived from the initial image, such as edge data, depth data, segmentation data, and/or pose data. As noted above, the conditioning data may include partial information about the initial image, but not the full initial image itself. According to the present disclosure, the difference description can be utilized to refine the caption and/or the machine-learned model. An iterative loop, which can be, and/or can include, a feedback loop with different description generation and caption/machine-learned model refinement can improve subsequent generation of more accurate synthetic images and/or image captions. The difference descriptions can include textual and/or other types of representations of differences between initial images and synthetic images.

Generation of the difference descriptions can be achieved through closed loops of captioning, generation, and evaluation. The difference descriptions are detailed, high quality, and grounded. The difference descriptions highlight weaknesses in understandings by machine-learned models of initial images, enabling the same or different model to adjust (refine) the caption of the initial images accordingly. The differences may be utilized to generate descriptions of images based on the conditions. The differences may be based on image-oriented conditions. The descriptions can include captions with visual-oriented details associated with the scenes. Certain existing methods of image description generation by machine-learned models are limited by inexhaustive and inadequate datasets used to train the machine-learned models. Additionally, descriptions generated by current machine-learned models, such as, for example, generative machine-learned models, lack detail and accuracy required for precise image reproduction.

In contrast, the technology described in the present disclosure expands and enhances generation of image descriptions, and generation of images utilizing the image descriptions. This method offers a more detailed, higher quality, and grounded image description generating approach utilizing conditions established by initial images, and differences reflected by comparisons between initial images and synthetic images. For example, machine-learned models generating and/or utilizing the captions to generate images, refine the machine-learned models, and/or refine the captions, can identify and/or abstract underlying patterns related to the images input into the machine-learned models. The captions and/or differences generated by the machine-learned models can enable the machine-learned models to generate and/or output new content more accurately and efficiently. The new content can be generated by the machine-learned models, such as, for example, models incorporating unsupervised and/or semi-supervised tasks, based on the generated captions and/or the generated differences.

Specifically, an example machine-learned model system can generate the captions and the differences based on images input into machine-learned models. The machine-learned models can generate captions associated with images. The captions generated by the machine-learned models can include detailed descriptions of content in the images being input as initial images. The machine-learned models, which can include generative models, can generate synthetic images, which can be generated using the captions. The machine-learned models can generate visual difference texts using the synthetic images and using conditions. The conditions can be generated based on the initial images, and/or visual structure data derived from the initial images.

An iterative cycle incorporating the machine-learned models can be utilized to analyze the images, generate content based on the analysis, and perform various functions utilizing the generated content, and/or the images being input. The machine-learned models can include caption generation models (e.g., such as the first machine-learned model) to input and analyze images. The caption generation model can generate the captions in response to analyzing the images. The captions can include visual descriptions of the images. The visual descriptions can include detailed textual descriptions of content in the images. The captions, such as, for example, captions generated during initial cycles, can include initial captions.

The machine-learned models can include image generation models (e.g., such as the second machine-learned model). The image generation models can recreate the images input into the caption generation models. For example, the image generation models can generate synthetic images utilizing the captions.

The machine-learned models can include multi-modal models (e.g., such as the third machine-learned model) to generate differences between the images input into the caption generation models and the synthetic images. The differences between the images input into the caption generation models and the synthetic images can be generated by the multi-modal models. The differences can be generated based on comparisons between the images input into the caption generation models and the synthetic images. Descriptions based on the differences can be generated by the multi-modal models. The descriptions can include various types of differences, such as visual differences between the images being compared. The differences may be based on comparisons between the initial images and the synthetic images.

The machine-learned models can include large language models (LLM). For instance, the large language models (e.g., such as the fourth machine-learned model) to analyze the differences and generate revised captions. The differences can include texts, such as the visual difference texts. The differences, including the visual difference texts, can be analyzed by the large language models. For example, the differences may be output by the multi-modal models and input into the large language models. The large language models can output the revised captions based on analysis of the descriptions, including the differences.

Improvements to both image understanding (e.g., captioning) and image generation are achieved through utilization of conditions and generation of difference descriptions. Therefore, systems and methods of enhanced image understanding and generation are provided herein. The present disclosure provides for a solution to the above-mentioned problems by allowing for refinement of synthetic image generation to be performed iteratively using initial image-based conditions, and using difference descriptions based on the initial image-based conditions. The iterative performing of the synthetic image generation can include an iterative cycle with two distinct modes. The modes are directed to applying the core concept of captioning initial images and utilizing captions to understand synthetic images and to generate better synthetic images. The cyclical loop for generating synthetic images aims to simultaneously improve understanding of images and enhance generative capabilities of machine-learned models.

For example, various aspects of the systems can be refined using the visual difference texts. The captions can be refined using the visual difference texts and utilized to generate additional synthetic images. Subsequently generated synthetic images may be relatively more accurate and realistic based on the refined captions. Image descriptions, which can include the visual difference texts, can be utilized to generate the additional synthetic images based on the refined captions. The synthetic images can be generated using an iterative loop, with the revised captions generated via the iterative loop being utilized to generate the synthetic images, which become increasingly more accurate. The synthetic images may become increasingly more accurate due to the refined captions becoming increasingly more accurate.

Alternatively or in addition, the machine-learned models (e.g., the generative models) generating the captions can be refined using the visual difference texts. The machine-learned models can be trained utilizing the captions. The machine-learned models can be trained utilizing the refined captions. The machine-learned models can be trained using an iterative loop. The machine-learned models being trained utilizing the refined captions may output the synthetic images, which may become increasingly more accurate due to the machine-learned models becoming increasingly more accurate. The machine-learned models may become increasingly more accurate due to the refined captions becoming increasingly more accurate.

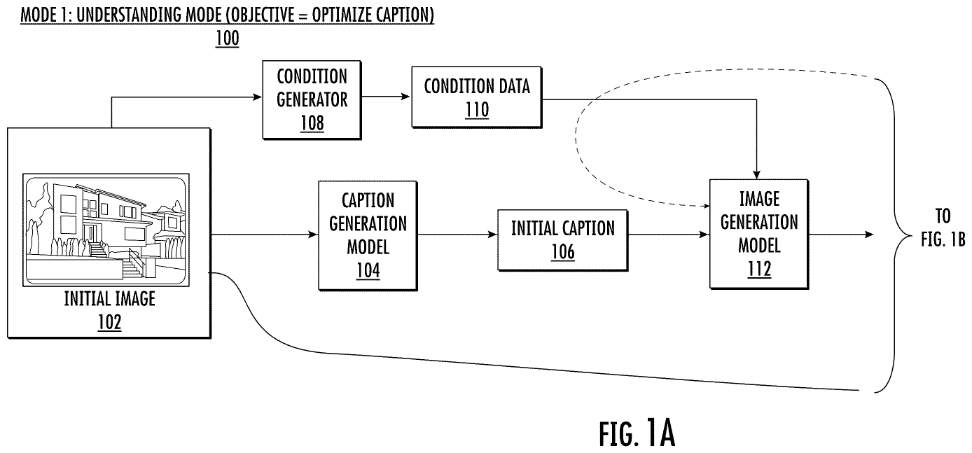

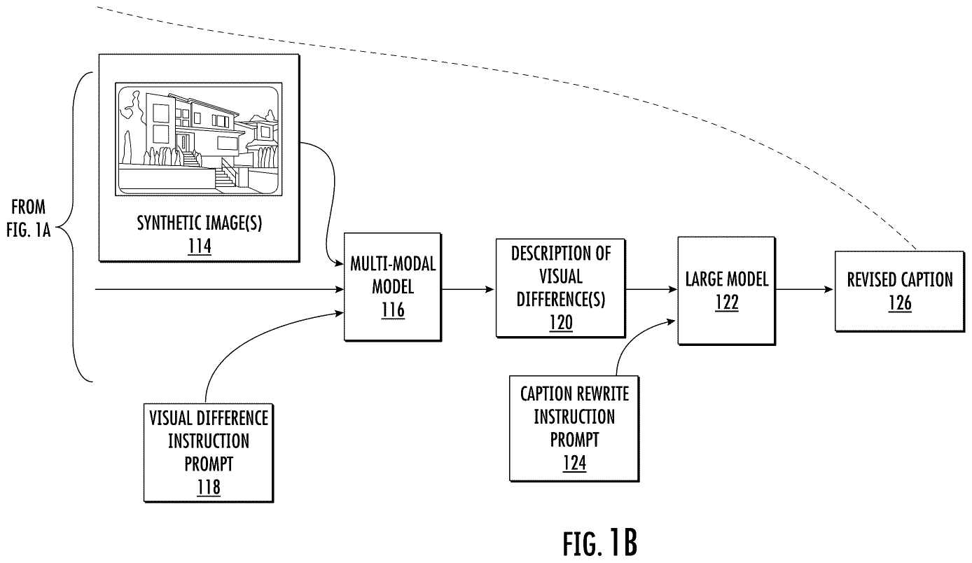

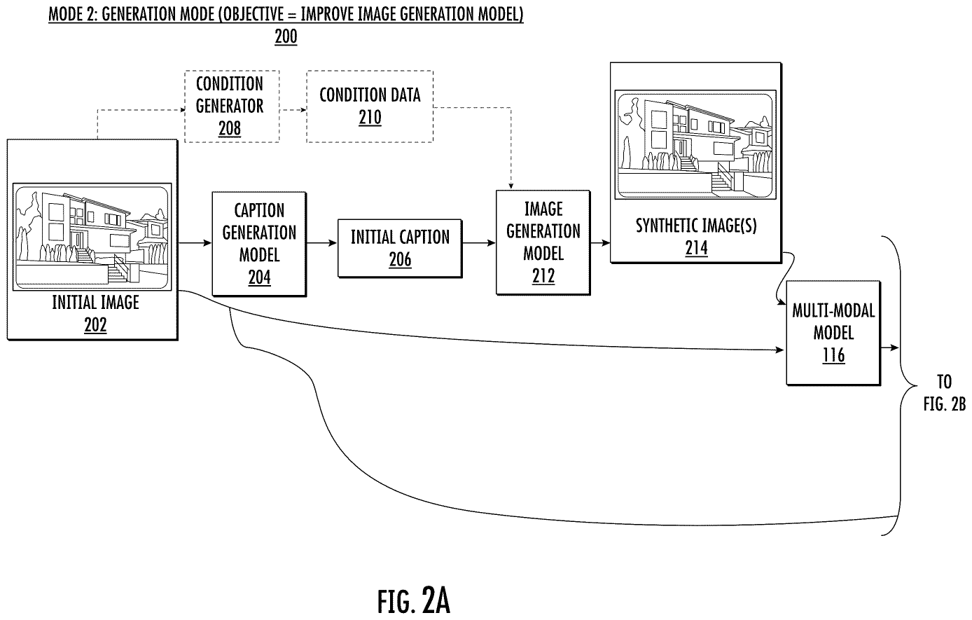

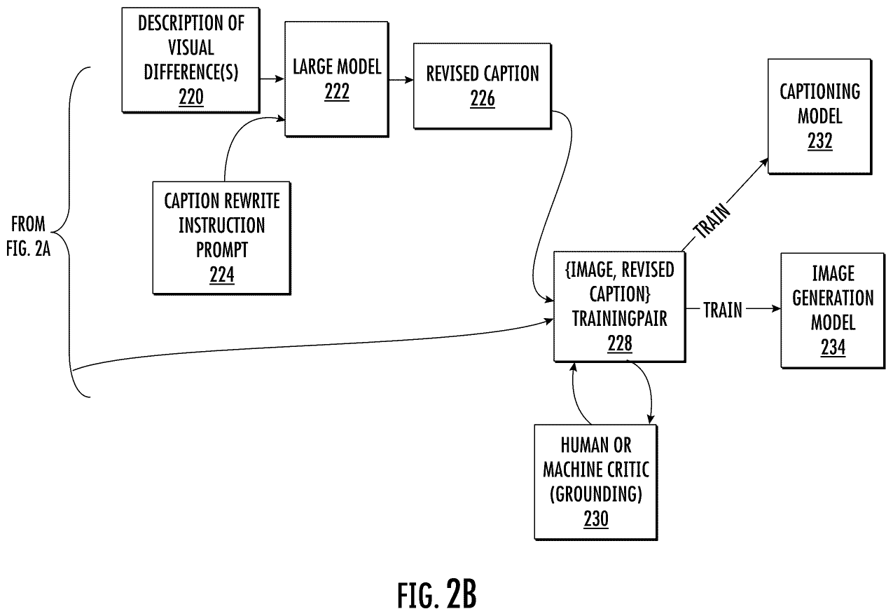

By way of a hypothetical example, the system operating according to the techniques discussed herein can be utilized to process images according to an algorithm that overcomes problems in existing systems. The algorithm can use generation and understanding in a loop that converges toward a grounded description of a scene. The loop can include a single iterative cycle with two distinct modes of operation. Both modes may be oriented toward achieving a core concept of captioning images to understand and generate better images (e.g., synthetic images). This cyclical process performed, via the loop, can be utilized to simultaneously improve understanding of images and enhance the generative capabilities of a generative model (e.g., an image generation model, such as the image generation model 112/212 as discussed below with reference to FIGS. 1A-2B).

The cyclical process overcomes problems of conventional technology that is unable to sufficiently, efficiently, and cost-effectively produce captions of visual content with desired characteristics. In contrast to the image captioning of conventional technology, the process performed according to the techniques discussed herein can produce highly grounded, detailed, and accurate descriptions of visual content. The process can utilize generative-based understanding to obtain detailed, high quality, and grounded image descriptions through a closed loop of captioning, generation, and evaluation. For instance, the process can be utilized to obtain high quality data for training the large models in a cost-effective, streamlined, and unburdensome manner. The captions obtained via the process discussed herein may be produced to exhaustively and precisely describe images and/or scenes such that the images and/or scenes are fully reproducible by the generative models.

The process according to the techniques discussed herein can include multiple modes, with a first mode oriented toward understanding and a second mode oriented toward generation. The first mode can utilize feedback from a comparison between an initial image and a synthetic image to refine the initially generated caption, itself. By identifying areas where the generated image deviates from the original, weaknesses in understanding of the initial image (e.g., as represented by the caption) can be pinpointed and utilized to adjust the caption accordingly. This iterative process of captioning, generation, comparison, and refinement can lead to a deeper understanding of the image and a more accurate and informative caption.

The second mode can focus on improving the generative model. The feedback from a comparison between the initial image and a synthetic image can be used to create detailed instructions for the generative model. The instructions may highlight specific elements to be added, removed, or modified to achieve a more accurate representation of the initial/original image. These instructions, along with the original image, can be stored as paired information for later use in fine-tuning the generative model. This process may allow the generative model to learn from its mistakes and improve its ability to generate images that align more closely with the intended content.

By seamlessly integrating these two modes (e.g., the first/understanding mode and second/generation mode) within a single iterative cycle, a continuous feedback loop may be established. Generating the images enhances understanding of the images, which in turn may lead to more refined instructions for the generative model. Utilization of the refined instructions may result in a robust system that not only produces high-quality images from captions but also deepens understanding of visual content through iterative refinement.

The increased understanding of the images and the more refined instructions for the generative model may be achieved via incorporation of conditioned captioning and conditioned generation (e.g., conditioned image generation). The conditioned captioning may be achieved by the image captioning model with textual input by one or more generative models of various types. The conditioned generation may be achieved with textual and/or visual conditioning, for example, such as via a ControlNet model.

A condition may be utilized by an image generation model that generates synthetic images utilizing an initial image (e.g., as a condition) and an initial caption. The condition may be provided via the initial image to the image generation model, which may thereby generate the synthetic images.

The synthetic images may be processed by a multi-modal model. The multi-modal model may act as a multi-modal agent to identify visual differences by comparing the input image against the generated image. The comparison may create a difference description of what is in the input image and not present in the generated image. A large language model may act as an aggregation agent to update the initial image caption with the difference description obtained from the comparison with image generation output.

In a hypothetical example, a server (e.g., any of the server(s) 302) can receive any number of prompts from a computing device (e.g., any of the server(s) 306 and/or the computing device(s) communicatively coupled to the server(s) 306). For instance, a prompt can include instructions regarding two images. One of the images can be an original image (e.g., the initial image 102, as discussed below with reference to FIGS. 1A and 1B). One of the images can be a synthetic image (e.g., the synthetic image 114, as discussed below with reference to FIGS. 1A and 1B). The server(s) 302 may have also previously produced a script with details regarding the original image, prior to receiving the prompt.

The prompt may include various types of information, such as the instructions detailing what operations are being requested to be performed. The instructions may indicate that the prompt was generated to request a comparison between the images, such as a comparison to identify, for each image, what is in the image that is not in the other image. The prompt may request, or the server may be programmed to automatically provide, a description of visual differences based on the comparison. The prompt may request, or the server may be programmed to automatically provide, a description of visual commonalities between the two images. Any requests in the prompt may be received via data in the prompt.

The server may produce unique descriptions of the images. The server may produce a unique description of the first image. The server may provide a unique description of the second image. Any or both of the unique descriptions may be generated as a caption. The descriptions of the first and second images can be generated as captions. The description of the first image may include an original caption (e.g., the initial caption 106, as discussed below with reference to FIGS. 1A and 1B). The second caption may possibly be generated as a revised caption (e.g., the revised caption 126, as discussed below with reference to FIGS. 1A and 1B). The revised caption can be provided as input to an image generation model (e.g., the image generation model 112, as discussed below with reference to FIGS. 1A and 1B).

The server may provide descriptions of differences and/or commonalities between the first and second images. The server may utilize the captions to provide the descriptions of the differences and/or the commonalities. The captions may be utilized without utilizing the images to provide the descriptions of the differences and/or the commonalities. Alternatively, the captions may be utilized along with the images to provide the descriptions of the differences and/or the commonalities. However, the current disclosure is not limited thereby, and the images may possibly be utilized without the captions to provide the descriptions of the differences and/or the commonalities.

The server may generate one or more captions based on the descriptions of differences and/or commonalities. The caption(s) can include a revised caption of the initial image, the synthetic image, or a combination thereof. The revised caption that is input to the image generation model can be generated based on the descriptions of differences and/or commonalities. However, the current disclosure is not limited thereby, and the revised caption can be generated based on the synthetic image, regardless of the descriptions of differences and/or commonalities.

The revised caption may be generated based on various types of data. For instance, the revised caption that is generated based on the synthetic image, and the revised caption that is generated based on the descriptions of differences and/or commonalities, may be separate from one another, different from one another, or the same as one another. Alternatively, the revised caption that is generated based on the synthetic image, and the revised caption that generated is based on the descriptions of differences and/or commonalities, may be integrated together as a single revised caption.

The captions of the original image and/or the synthetic image may include various details depicted respectively therein. For instance, the caption of the synthetic image may indicate that a type of surrounding light includes faint light and a surrounding environment includes a twilight sky, that a house includes interior lights turned on to highlight an interior of a house, that a landscape is darker and that a house is still well lit, and that a surrounding area of a house includes a foreground with a fence and a stone wall.

The description of commonalities between the captions of the original and synthetic images may include various details. For instance, the description of commonalities may indicate that both images show the same house, such as a modern two-story home with a white exterior, a dark roof, and large windows, that both images are taken from the front of the house, that both images show a driveway, steps, and a railing, that both images have similar landscaping around the house, and that both images have a house to the right of the main house.

The captions, and/or the descriptions of commonalities and/or differences may be utilized to generate revised captions. The revised captions may be generated based on a prompt (e.g., a new prompt), and/or automatically based on the captions and/or descriptions generated in response to receiving the prompt (e.g., the previous prompt), discussed above. The descriptions may indicate commonalities and/or differences. A revised caption may include updated information of the original imager, with extra information. The revised caption may include details in the initial caption and/or extra information. For instance, the revised caption (e.g., that is generated based on the commonalities) may indicate that a characteristic of a scene includes a serene scene with a modern, two-story house bathed in the warm glow of a sunny day, that the house boasts a striking white exterior with stylish brown accents (e.g., a slightly angled roof adding a touch of contemporary flair), that the house includes large windows, framing picturesque views of the lush greenery surrounding the property, that the windows flood the interior with natural light, that the house includes a set of concrete stairs illuminated by subtle spotlights, that the stairs lead up to the expansive front door with its sleek black frame, which stands invitingly open, that the landscaping is well-maintained, featuring vibrant green trees and manicured bushes, that the landscaping complements the house's modern design, that a pristine white car is parked to the left, that the car adds a touch of everyday luxury, that a concrete wall adorns the house with the address “5034,” that the concrete wall anchors the scene, hinting at a quiet, residential neighborhood, that the overall impression of the scene is one of tranquility and sophisticated living, captured in a moment of bright, natural light, that the natural light accentuates the house's architectural beauty, and that the environment in the scene includes lush, peaceful surroundings.

The captions, the descriptions of commonalities and/or differences, the revised captions, revised descriptions, and so on, may be generated, in an iterative loop. The iterative loop may be performed to generate the captions/descriptions, as discussed above, and any number of additional captions/descriptions. The captions/descriptions may be increasingly accurate and/or detailed at each subsequent iterative loop. Synthetic images may be generated, as discussed above, for each cycle of the iterative loop, which may match the original image with increasing accuracy and detail with respect to the original image. Respective levels of accuracy and/or detail associated with the captions/descriptions/synthetic images may increase with each cycle of the iterative loop.

The original image may be utilized as a condition for generation of the synthetic images. For instance, the original image may be input as a condition into a machine-learned model (e.g., the image generation model 112, as discussed below with respect to FIGS. 1A and 1B). The synthetic images may be generated by the image generation model processing the captions/descriptions, based on the condition.

The systems and methods of the present disclosure provide a number of technical effects and benefits. As one example, the technology can enhance the accuracy of image captioning and generation by using a cyclical process that integrates feedback from visual difference texts. For instance, a machine-learned model can generate a caption describing the content of an initial image. Subsequently, another model can use this caption to create a synthetic image. A third model can then analyze both the initial and synthetic images to identify and describe visual discrepancies. This detailed feedback can be used to refine the caption and improve the model's understanding of the image content, thereby enhancing the generation of more accurate synthetic images in future cycles. This iterative refinement process can significantly contribute to reducing errors in image understanding and generation.

Thus, the present disclosure provides a more straightforward and efficient approach to fine-tuning machine-learned models utilized to generate visual differences, and/or synthetic images based on the visual differences. Such advancements offer potential improvements in computational efficiency, model adaptability, and operational performance.

Moreover, the technology can leverage conditioning data derived from the initial image to guide the generation of synthetic images, thereby improving the relevance and accuracy of the generated images. For example, visual structure data such as edge data, depth data, segmentation data, or pose data can be extracted from the initial image. This data can then be used to condition the generative model (e.g., image generation model), helping to ensure that the synthetic image retains structural and spatial attributes of the original. By incorporating these visual cues, the model can produce images that are largely aligned with the structure of the initial image, but which may still demonstrate certain visual differences that highlight details that are missing from the initial caption.

Furthermore, the proposed system can utilize a dual-mode iterative cycle, allowing for improvements either in the understanding of the image or in the image generation capabilities. In the understanding mode, the system focuses on refining the captions to increase the descriptive accuracy, while in the generation mode, the emphasis shifts to enhancing the generative model based on the detailed instructions derived from the feedback loop. This dual-mode approach enables the system to adapt to different operational needs. Furthermore, alternating between the two modes can enable the models being improved in each mode to benefit from improvements in the model which were improved in the other mode, and vice versa.

The proposed techniques provide significant technical effects and benefits. One example technical effect is the increased computational efficiency in fine-tuning machine-learned models, such as caption generation models, image generation models, multi-modal models, large language models, and/or one or more additional models of various types. By using an iterative loop to generate refined captions used for multiple purposes, including subsequent generation of synthetic images and training of machine learned models, the methodology significantly reduces the complexity associated with traditional techniques that do not incorporate image-oriented conditions and visual differences into synthetic image generation. In particular, the iterative loop using the image-oriented conditions and visual differences reduces computing needed for obtaining synthetic images that exceed accuracy thresholds. This improvement considerably reduces the consumption of computational resources, including memory and processing power. This reduction is primarily due to the avoidance of numerous training cycles that would otherwise be dedicated to training the machine-learned models and for fine-tuning the machine-learned models, an often resource-intensive process. Consequently, the proposed approach allows for more efficient use of computational resources. Various example implementations are described herein with respect to the accompanying Figures.

FIGS. 1A and 1B are block diagrams depicting an example refinement 100 to a caption using a caption, initial image condition, and visual difference text aggregation-based synthetic image comparison according to example embodiments of the present disclosure. The refinement 100 can be performed by one or more machine-learned models in mode, such as a first mode (or “Mode 1”). The first mode may include an understanding mode with an objective to optimize a caption. The caption being optimized may include any caption generated based on any initial image. Individual ones of the machine-learned model(s) may be utilized to implement, and/or may be implemented via, any of the machine-learned model(s) as discussed above with reference to FIGS. 1A and 1B.

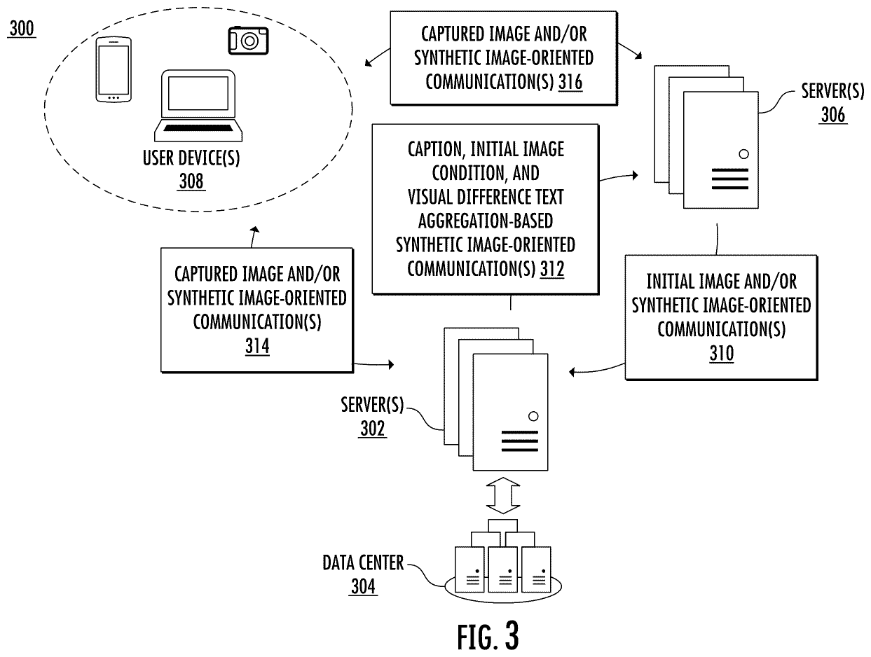

The refinement 100 can be performed utilizing the machine-learned model(s) to refine how results of analysis performed by the machine-learned model(s) are generated. The refinement 100 can be performed utilizing an initial image 102. The initial image 102 can include an image captured by a camera (e.g., a user device 308, as discussed below with reference to FIG. 3), and/or by any of the user device(s) 308. The initial image 102 can be analyzed by the machine-learned model(s).

The machine-learned model(s) can include a machine-learned model (or “caption generation model”) 104 utilized to generate one or more captions, such as an initial caption 106. The caption(s) can be generated based on the initial image 102. The caption(s) can include information, such as one or more descriptions associated with the initial image 102. The description(s) can include one or more written descriptions, such as text (e.g., one or more textual descriptions), associated with content depicted in the initial image 102. The caption generation model 104 can generate the caption(s) based on analysis performed by the caption generation model 104 of the initial image 102.

The refinement 100 can be performed utilizing a machine-learned model (or “condition generator”) 108 to generate one or more conditions based on an initial image 102. For example, the condition generator 108 can generate condition data 110, which can include the condition(s). The condition generator 108 can receive, as input, the initial image 102, analyze the initial image 102, and generate, as output, the condition data 110.

The machine-learned model(s) can include a machine-learned model (or “image generation model”) 112 utilized to generate one or more images, individual ones of which can include a synthetic image 114. The image generation model 112 can generate the synthetic image(s) 114 based on a condition (e.g., from among the condition(s) in the condition data 110). The condition can be generated based on, and/or can include, the initial image 102. For instance, the image generation model 112 can generate the synthetic image(s) 114 using the initial caption 106, based on the condition data 110.

In some examples, the synthetic image(s) 114 can (endeavor to) depict the same scene or other visual content as the initial image 102. Specifically, in some examples, the synthetic image(s) 114 can (endeavor to) depict the same scene or other visual content as the initial image 102, but from an alternative viewpoint or perspective. Thus, in some instances, the synthetic image(s) 114 are intended to be of the same object but from different perspectives. In other cases, the synthetic image(s) 114 are intended to be of the same or similar scene or object from the same viewpoint or perspective.

In some examples, the image generation model 112 can be utilized to manage (e.g., identify, determine, analyze, store, modify, delete, etc.) the caption(s) to generate the synthetic image(s) 114. In such an example or another example, the image generation model 112 can be utilized to analyze the caption(s), such as the initial caption 106, and generate the image(s), such as one or more synthetic images 114. The synthetic image(s) 114 can be generated based on the initial caption 106, the condition data 110, and, possibly, a revised caption (e.g., the revised caption 126, as discussed below in further detail). For instance, the synthetic image(s) 114 can be generated based on the condition (e.g., the initial image 102). The synthetic image(s) 114 can be generated by the image generation model 112 in response to analyzing the initial caption 106 (e.g., and, possibly, the revised caption 126), based on the initial image 102.

Utilization of the condition can be incorporated into generation of the synthetic image(s), via analysis of the condition (e.g., the initial image 102). The condition can be utilized, such as by the image generation model 112, which can include a neural network structure. The neural network structure can be utilized to control diffusion models by adding one or more extra conditions. For instance, the neural network structure can include ControlNet. The extra condition(s) can include the condition, such as the initial image 102. ControlNet can copy weights of neural network blocks into a locked copy and a trainable copy. The trainable copy can learn the condition; and the locked copy can preserve the model so that fine-tuning of the model may be performed without negatively impacting the original model.

The machine-learned model(s) can include a machine-learned model (or “multi-modal model”) 116 utilized to generate one or more descriptions. The description(s), such as a description of one or more visual differences 120, can include text describing one or more visual difference(s). The description(s) (or “difference description(s),” or “visual description(s),” or “visual difference description(s)”), which can include the description (or “difference description”) 120, can be generated based on the initial image 102 and the synthetic image(s) 114.

The description(s) can be generated based on one or more comparisons between images. The comparison(s) can be performed with individual ones of the synthetic image(s) 114 and with the initial image 102. In some examples, the comparison(s) can be performed between individual ones of the synthetic image(s) 114 and with the initial image 102. For instance, a comparison between a synthetic image 114 and the initial image 102 may be performed by analyzing one or more differences between the synthetic image 114 and the initial image 102.

The description(s), including the description 120, may be generated by the multi-modal model 116 based on one or more visual difference instruction prompts (also simply referred to herein as “prompt(s)”), such as a visual difference instruction prompt 118. In such an example or another example, the multi-modal model 116 can analyze the synthetic image(s) 114 and the initial image 102, in response to identifying (e.g., receiving) the prompt 118. The description 120 can be generated by the multi-modal model 116 in response to analyzing the synthetic image(s) 114 and the initial image 102.

The machine-learned model(s) can include a large-language model (or “large-language model”) 122 utilized to generate one or more captions. The caption(s) can be generated based on one or more caption rewrite instruction prompts (also simply referred to herein as “prompt(s)”), such as a caption rewrite instruction prompt 124. The caption(s) can include one or more revised captions. For example, the revised caption(s) can include a revised caption (or “refined caption) 126 generated by the large-language model (also simply referred to herein as “large model”) 122. The large-language model 122 can be utilized to manage (e.g., identify, determine, analyze, store, modify, delete, etc.) the description(s), such as the description 120. In such an example or another example, the large-language model 122 can analyze the description 120, based on the description 120 being input into the large-language model 122. The large-language model 122 can analyze the description 120 and the prompt 124. In some examples, the large-language model 122 can analyze the description 120, in response to identifying (e.g., receiving) the description 120 output by the multi-modal model 116. The revised caption 126 can be generated by the large-language model 122 in response to analyzing the description 120.

The revised caption(s) can be generated by the large-language model 122 based on the visual description(s) (e.g., the description(s) 120) in various ways. In some examples, the large-language model 122 can generate the revised caption 126 by modifying (e.g., expanding, refining, smoothing, simplifying, and/or utilizing in various other ways) the visual description(s) 120. The visual description(s) 120 can be modified to be modified visual description(s), for example, with a different type of data. For instance, the visual description(s) 120, and/or information therein can be utilized to generate a separate, and/or different, type of data output as the revised caption 126. For instance, the different types of data can include data with one or more different characteristics, such as a different type of packaging, field, format, length, scope, complexity, etc., or any combination thereof. In some examples, for instance with the revised caption 126 including the different type of data as the modified visual description(s), the revised caption 126 can be different from the modified visual description(s) with respect to the various characteristics.

Alternatively, the visual description(s) 120 can be modified, and the modified visual description(s) (or “revised visual description(s)”) can be output as the revised caption 126. For instance, the revised caption 126 may include a same type of data as the modified visual description(s). In some examples, for instance with the revised caption 126 including the same type of data as the modified visual description(s), the revised caption 126 can be the same as the modified visual description(s).

The refinement 100 can include inputting the revised caption(s), such as the revised caption 126, into the image generation model 112. The image generation model 112 can be utilized to manage (e.g., identify, determine, analyze, store, modify, delete, etc.) the revised caption 126. In some examples, the image generation model 112 can generate one or more synthetic images based on the revised caption 126, in a similar way as for the initial caption 106, as discussed above. The image generation model 112 can generate the synthetic image(s) (e.g., which may be included in the synthetic image(s) 114) based on the revised caption 126 and the condition data 110, based on the initial image 102).

The refinement 100 can include one or more iterations (e.g., one or more iteration loops) (or “iterative operation(s)”). For example, any number of iterations can be performed utilizing any of the data and/or machine-learned models in the refinement 100. In some instance, as first iteration can be performed utilizing the initial caption (e.g., a first caption) 106, the synthetic image(s) 114, the description (e.g., a first description) 120, and the revised caption (e.g., a first revised caption) 126. In such an instance or another instance, a different iteration (e.g., a second iteration) can be performed utilizing the first revised caption 126 or another revised caption generated based on the first revised caption. In such an instance or another instance, the second iteration can be performed utilizing one or more other synthetic images (e.g., one or more second synthetic images based on the first revised caption and/or the other revised caption), a different description (e.g., a second description based on the synthetic image(s) 114), and a different revised caption (e.g., a second caption based on the second description). In such an instance or another instance, one or more other iterations (e.g., one or more subsequent iterations) can be performed in a similar way as for the first and/or second iteration.

Although the refinement 100 can include the caption generation model 104, the image generation model 112, the multi-modal model 116, and the large-language model 122, as discussed above in the current disclosure, it is not limited as such. In some examples, individual ones of the caption generation model 104, individual ones of the image generation model 112, individual ones of the multi-modal model 116, and/or individual ones of the large-language model 122 can include any number of models (e.g., machine-learned models) of any types. Alternatively or additionally, any combination of the caption generation model 104, the image generation model 112, the multi-modal model 116, and/or the large-language model 122 can be integrated together as an integrated model (e.g., an aggregated model, etc.) to perform any combinations of operations thereby, as discussed through the current disclosure.

Various descriptions of various types can be generated by analyzing the synthetic image(s) 114, based on the initial image 102. Individual ones of the descriptions can be analyzed in a similar way, alternatively or in addition to, analysis of the description 120. Results of analysis of individual ones of the descriptions, and/or output associated therewith, can be utilized in a similar way, alternatively or in addition to, results of analysis of the description 120, and/or output associated therewith. For instance, a description indicating one or more commonalities may be generated and/or utilized in a similar way as for the difference(s). The description (e.g., a textual description) indicating the commonality(ies) may be separate from, and/or integrated with, the description (e.g., the textual description) indicating the difference(s).

FIGS. 2A and 2B are block diagrams depicting an example refinement 200 to a machine-learned model using a caption, initial image condition, and visual difference text aggregation-based synthetic image comparison according to example embodiments of the present disclosure. The refinement 200 can be performed by one or more machine-learned models in mode, such as a second mode (or “Mode 2”). The second mode may include a generation mode with an objective to improve an image generation model. The image generation model being optimized may include any image generation model optimized based on any initial image. Individual ones of the machine-learned model(s) may be utilized to implement, and/or may be implemented via, any of the machine-learned model(s) as discussed above with reference to FIGS. 1A and 1B.

The refinement 200 can be performed utilizing one or more images, such as an initial image 202, and the machine-learned model(s), such as a caption generation model 204. For example, the initial image 202 can be input into the caption generation model 204, which can be utilized to manage (e.g., identify, determine, analyze, store, modify, delete, etc.) the initial image 202, and to generate one or more captions, such as an initial caption 206.

The refinement 200 be performed utilizing a machine-learned model (or “condition generator”) 208 to generate one or more conditions based on an initial image 202. For example, the condition generator 208 can generate condition data 210, which can include the condition(s). The condition generator 208 can receive, as input, the initial image 202, analyze the initial image 202, and generate, as output, the condition data 210.

The refinement 200 can be performed utilizing the initial caption 206 being input into the machine-learned model(s), such as an image generation model 212. The image generation model 212 can be utilized to manage (e.g., identify, determine, analyze, store, modify, delete, etc.) the initial caption 206, and to generate one or more synthetic images, such as one or more synthetic images 214. The image generation model 212 can generate the synthetic image(s) 214 based on a condition (e.g., from among the condition(s) in the condition data 210). The condition can be generated based on, and/or can include, the initial image 202. For instance, the image generation model 212 can generate the synthetic image(s) 214 using the initial caption 206, based on the condition data 210.

The refinement 200 can be performed utilizing the synthetic image(s) 214 being input into the machine-learned model(s), such as a multi-modal model 216. The multi-modal model 216 can be utilized to manage (e.g., identify, determine, analyze, store, modify, delete, etc.) the synthetic image(s) 214 and the initial image 202, such as, based on a prompt (or “visual difference instruction prompt”) 218. The multi-modal model 216 can generate one or more descriptions, such as a description (or “description of visual differences(s)”) of one or more visual descriptions 220.

The refinement 200 can be performed utilizing the description 220 being input into the machine-learned model(s), such as a large language model (or “large model”) 222. The large language model 222 can be utilized to manage (e.g., identify, determine, analyze, store, modify, delete, etc.) the description 220, such as, based on a prompt (or “caption rewrite instruction prompt”) 224. The large language model 222 can generate one or more captions, such as a revised (or “refined caption”) 226.

In some examples, the initial image 202, the initial caption 206, the condition data 210, any of the synthetic image(s) 214, the description 220, and/or the revised caption 226 may be the same as, or different from, the initial image 102, the initial caption 106, the condition data 110, any of the synthetic image(s) 114, the description 120, and/or the revised caption 126, respectively. In those or other examples, the caption generation model 204, the condition generator 208, the image generation model 212, the multi-modal model 216, and/or the large model 222 may include, or be included in, the caption generation model 104, the condition generator 208, the image generation model 112, the multi-modal model 116, and/or the large model 122, respectively.

While the refinement 200 can be performed utilizing the condition generator 208 and the condition data 210, as discussed above in the current disclosure, it is not limited as such. In some examples, the refinement 200 can be performed without utilizing the condition generator 208 and the condition data 210, by generating, via the image generation model 212, the synthetic image(s) 214 based on the initial caption 206 (e.g., without inputting any of the condition(s)).

The refinement 200 can be performed utilizing one or more training pairs for training individual ones of the machine-learned model(s) based on various portions of data utilized in the refinement 200. In some examples, individual ones of the training pair(s), such as a training pair (or “{image, revised caption} training pair”) 228, can be generated based on the image(s) and/or the caption(s). In those or other examples, individual ones of the training pair(s) can be generated based on the initial image 202, the caption 206, the synthetic image(s) 214, the description 220, and/or the revised caption 226. For instance, the training pair 228 can include the initial image 202, for example, as a training initial image. In such an instance or another instance, the training pair 228 can include the revised caption 226, for example, as a training revised caption.

Individual ones of the training pairs can be generated utilizing grounding via one or more humans and/or one or more machine critics (or “machine-learned critic(s)”). For example, the training pair (or “{image, revised caption} training pair”) 228 can be generated utilizing grounding via the human(s) and/or the ground machine critic(s), such as a human or machine critic (or “human or machine critic (grounding)”) 230. In some instances, the machine-learned models, and/or, possibly, the human or machine critic 230, can ground the training pair 228 to structured data sources (e.g., the initial image 202). The human or machine critic 230 can provide one or more selections via input to one or more computing devices (e.g., the server(s) 302, as discussed above with reference to FIG. 3, and/or one or more computing devices communicatively coupled thereto). The selection(s) can be utilized, such as by the computing device(s), to ground the training pair 228.

The selection(s), for example, being associated with the human or machine critic 230, can be utilized to provide training data. The selection(s) can include (e.g., provide, generate, and/or be utilized to obtain) one or more labels associated with, and/or included in, the training data, such as the initial image 202 and/or the revised caption 226, being managed (e.g., analyzed, utilized, allocated, repurposed, etc., or any combination thereof) as the training initial image and/or the training revised caption, respectively. The label(s) can include meaningful and informative information, for example, to provide context so that the machine-learned model(s) can learn from it.

The label(s) may indicate various types of information. For example, the label(s) may indicate whether the initial image 202 includes one or more various objects, such as a house, a driveway, a yard, etc., or any combination thereof. In such an example or another example, the label(s) may indicate whether the initial image 202 includes sunlight (e.g., associated with a sunny day). In such an example or another example, the label(s) may indicate one or more relationships (e.g., physical, structural, dimensional, etc., or any combination thereof) between the objects. In such an example or another example, the label(s) indicate one or more characteristics (e.g., one or more colors, one or more sizes, one or more shapes, etc., or any combination thereof) associated with the object(s), or any combination thereof.

The training pair 228 may be utilized to train individual ones of the machine-learned model(s). In some examples, the training pair 228 may be utilized to train a captioning model 232. For instance, the captioning model 232 being trained via the training pair 228 may include the caption generation model 212. In those or other examples, the training pair 228 may be utilized to train an image generation model 234. For instance, the image generation model 234 being trained via the training pair 228 may include the image generation model 212.

Similar to the refinement 100, the refinement 200 can be performed utilizing one or more iterative loops. The refinement 200 may include any number of iterations performed utilizing any of the machine-learned model(s) and/or the data utilized by, and/or included in, the refinement 200.

FIG. 3 depicts an example environment 300 for caption, initial image condition, and visual difference text aggregation-based synthetic image-oriented management performed by systems, and performed via methods therewith, according to example embodiments of the present disclosure. In some examples, the environment 300 can include one or more servers 302 utilized to manage (e.g., identify, determine, generate, store, retrieve, obtain, forward, modify, delete, etc.) one or more machine-learned models. In alternative or additional examples, the environment 300 can include one or more datacenters (also referred to herein simply as “datacenter”) 304 utilized to manage the machine-learned models. In some examples, the datacenter 304 can include one or more databases utilized to manage (e.g., store, retrieve, obtain, forward, modify, delete, etc., or any combination thereof) the machine-learned models.

The server(s) 302 may be integrated within, combined with, or separate from the datacenter 304. For example, any operations performed by the server(s) 302 may be performed by the datacenter 304, and/or vice versa. In such an example or another example, any components included in the server(s) 302 may be included in the datacenter 304, and/or vice versa.

The environment 300 can include one or more servers 306, individual ones of which may be managed by, and/or associated with, one or more operators and/or providers of the server(s) 302. The server(s) 306 may include one or more servers managed by, and/or associated with, one or more clients (e.g., and/or one or more operators, thereof). The client(s) may operate any of the server(s) 306, such as, for instance, one or more external servers, one or more remote servers, etc. Individual ones of the server(s) 306 may include a computing device of any type.

The environment 300 can include one or more user devices 308. The user device(s) 308 may be associated with one or more users. Individual ones of the user device(s) 308 can include a computing device of any type. In some examples, the user device(s) 308 can be utilized to capture one or more images. For instance, an image captured by a user device 308 may include an initial image (or “captured image”).

The server(s) 302, the server(s) 306, and/or the user device(s) 308 may communicate with one another. For example, the server(s) 302, the server(s) 306, and/or the user device(s) 308 may exchange one or more communications with one another. The communication(s) depicted in FIG. 3 can include one or more communications 310 exchanged between the server(s) 302 and the server(s) 306. The communication(s) (or “initial image and/or synthetic image-oriented communication(s)”) 310 may be utilized to exchange data, such as the initial image(s) and/or the synthetic image(s). Alternatively or in addition, the communication(s) 310 may be utilized to exchange information, one or more requests, and/or one or more responses associated with the initial image(s) and/or the synthetic image(s).

The communication(s) 310 may include initial images utilized to generate synthetic images. In some examples, a communication 310 may be transmitted by the server(s) 306 and to the server(s) 302. The communication 310 transmitted by the server(s) 306 may include an initial image utilized by the machine-learned models to generate a synthetic image. The synthetic image may be generated by the server(s) 302, such as by one or more operations/actions as discussed above with reference to FIGS. 1A-2B.

The communication(s) depicted in FIG. 3 can include one or more communications 312 exchanged between the server(s) 302 and the server(s) 306. The communication(s) (or “caption, initial image condition, and visual difference text aggregation-based synthetic image-oriented communication(s)”) 312 may be utilized to exchange data, such as the one or more synthetic images generated by the machine-learned models. Alternatively or in addition, the communication(s) 312 may be utilized to exchange information, one or more requests, and/or one or more responses associated with the synthetic image(s). For instance, a communication 312 may include a synthetic image generated by the machine-learned models.

The synthetic image (e.g., provided in the communication 312) may be generated based on the initial image, and/or one or more captions associated with the initial image. Alternatively or in addition, the synthetic image (e.g., provided in the communication 312) may be generated based on a condition associated with the initial image. Alternatively or in addition, the synthetic image (e.g., provided in the communication 312) may be generated based on one or more differences between the initial image and another synthetic image (e.g., an intermediary synthetic image). In some examples, utilization of the condition can be incorporated into generation of the synthetic image via analysis of the caption(s), such as with a neural network structure to control diffusion models by adding one or more extra conditions. For instance, the neural network structure can include ControlNet.

The caption(s) can be utilized to generate one or more descriptions associated with comparisons between the initial image and the synthetic image(s). For instance, a description being generated can identify one or more differences between the initial image and a synthetic image, and/or between the initial image and/or synthetic images (e.g., a collection of synthetic images). Alternatively or additionally, the description can identify one or more commonalities between the initial image and a synthetic image, and/or between the initial image and/or the synthetic images (e.g., the collection). One or more additional captions (e.g., one or more revised captions) can be generated based on the initial image, the initial caption, the synthetic image(s), and/or the description(s). One or more additional descriptions (e.g., one or more revised descriptions) can be generated based on the initial image, the caption(s), and the synthetic image(s), the description(s), and/or the revised caption(s).

The description(s) can be generated in various ways. In various cases, individual ones of the descriptions can be generated by analysis of the synthetic image(s), based on a condition (e.g., the initial image).

The captions, the description(s), the revised caption(s), the revised description(s), and so on, may be analyzed and/or generated, in an iterative loop. The iterative loop may be performed to analyze and/or generate the caption(s)/description(s)/synthetic image(s), and/or the additional caption(s)/description(s)/synthetic image(s).

The communication(s) depicted in FIG. 3 can include one or more communications 314 exchanged between the server(s) 302 and the user device(s) 308. Individual ones of the communication(s) (or “captured image and/or synthetic image-oriented communication(s)”) 314 transmitted by the user device(s) 308 and to the server(s) 302 may include data and/or information that is the same as, or different from, that of any of the communication(s) 310. For instance, a communication 314 transmitted by the user device(s) 308 may be the same type as, or a different type than, any of the communication(s) 310.

Individual ones of the communication(s) 314 transmitted by the server(s) 302 and to the user device(s) 308 may include data and/or information that is the same as, or different from, that of any of the communication(s) 312. For instance, a communication 314 transmitted by the server(s) 302 may be the same type as, or a different type than, any of the communication(s) 312.

The communication(s) depicted in FIG. 3 can include one or more communications 316 exchanged between the server(s) 306 and the user device(s) 308. Individual ones of the communication(s) (or “captured image and/or synthetic image-oriented communication(s)”) 316 transmitted by the user device(s) 308 and to the server(s) 306 may include data and/or information that is the same as, or different from, that of any of the communication(s) 314 transmitted by the server(s) 302. For instance, a communication 316 transmitted by the user device(s) 308 may be the same type as, or a different type than, any of the communication(s) 314 transmitted by the user device(s) 308.

Individual ones of the communication(s) 316 transmitted by the server(s) 306 and to the user device(s) 308 may include data and/or information that is the same as, or different from, that of any of the communication(s) 314 transmitted by the server(s) 302. For instance, a communication 316 transmitted by the server(s) 306 may be the same type as, or a different type than, any of the communication(s) 314 transmitted by the server(s) 302.

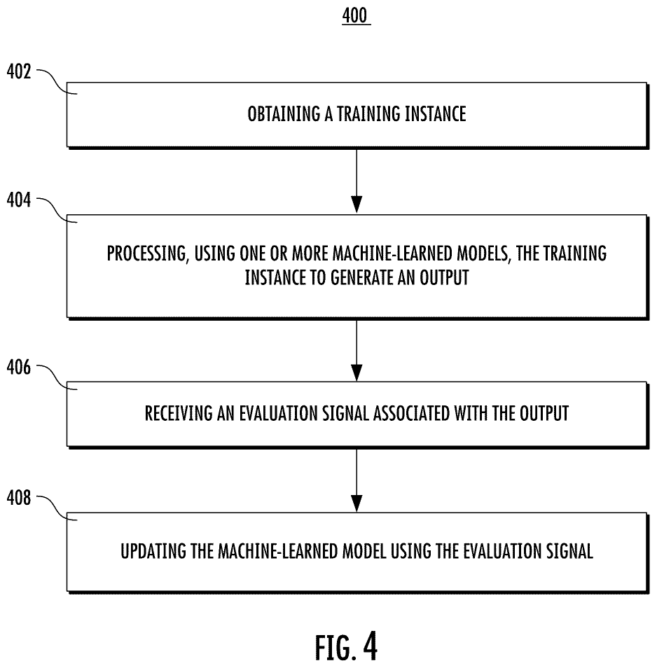

FIG. 4 depicts a flowchart of a method 400 for training one or more machine-learned models according to aspects of the present disclosure. For instance, an example machine-learned model can include individual ones of a caption generation model 104/204, a condition generator 108/208, an image generation model 112/212, a multi-modal model 116/216, and a large model 122/222.

One or more portion(s) of example method 400 can be implemented by a computing system that includes one or more computing devices such as, for example, computing systems described with reference to the other figures. Each respective portion of example method 400 can be performed by any (or any combination) of one or more computing devices. Moreover, one or more portion(s) of example method 400 can be implemented on the hardware components of the device(s) described herein, for example, to train one or more systems or models. FIG. 4 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 4 is described with reference to elements/terms described with respect to other systems and figures for exemplary illustrated purposes and is not meant to be limiting. One or more portions of example method 400 can be performed additionally, or alternatively, by other systems.

At 402, example method 400 can include obtaining a training instance. A set of training data can include a plurality of training instances divided between multiple datasets (e.g., a training dataset, a validation dataset, or testing dataset). A training instance can be labeled or unlabeled. Although referred to in example method 400 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 404, example method 400 can include processing, using one or more machine-learned models, the training instance to generate an output. The output can be directly obtained from the one or more machine-learned models or can be a downstream result of a chain of processing operations that includes an output of the one or more machine-learned models.

At 406, example method 400 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 408, example method 400 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 400 can include implementing a number of generalization techniques (e.g., weight decays, dropouts, etc.) to improve the generalization capability of the models being trained.

In some implementations, example method 400 can be implemented for training a machine-learned model from an initialized state to a fully trained state (e.g., when the model exhibits a desired performance profile, such as based on accuracy, precision, recall, etc.).

In some implementations, example method 400 can be implemented for particular stages of a training procedure. For instance, in some implementations, example method 400 can be implemented for pre-training a machine-learned model. Pre-training can include, for instance, large-scale training over potentially noisy data to achieve a broad base of performance levels across a variety of tasks/data types.

In some implementations, example method 400 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 400 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 400 can be implemented to execute parameter-efficient fine-tuning methods, such as Layerwise Optimization of Residuals (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

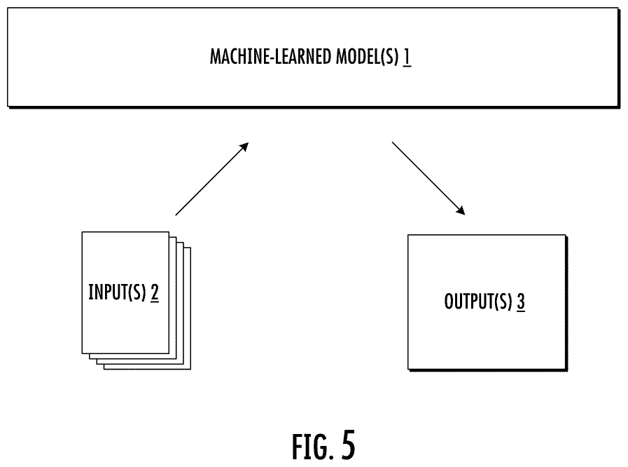

FIG. 5 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more of the caption generation model 104, the image generation model 112, the multi-modal model 116, and the large-language model 122, etc. Although various features, variations, and implementations described below are described with respect to machine-learned model(s) 1, it is to be understood that such features, variations, and implementations are to be understood as described with respect to each of the caption generation model 104, the image generation model 112, the multi-modal model 116, and the large-language model 122, etc., any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, ARXIV:1242.09368v2 (Oct. 14, 1022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

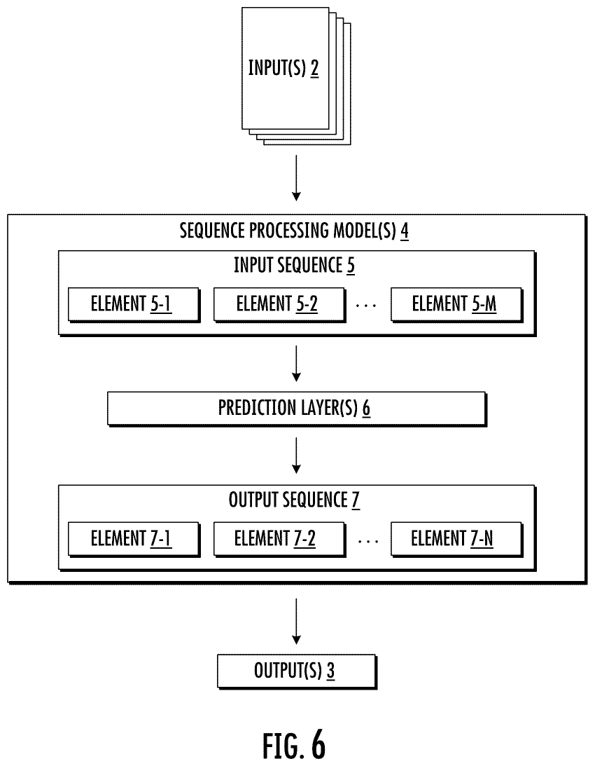

FIG. 6 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models are referred to as language models and can leverage language-based understandings across one or multiple modalities of input information. Sequence processing model(s) 4 can include relatively large models (e.g., more parameters, computationally expensive, etc.), which may be referred to as “Large Language Models” or LLMs. Sequence processing model(s) 4 can include relatively small models (e.g., fewer parameters, computationally lightweight, etc.), which may be referred to as “Small Language Models” or SLMs. Example language models include, for instance, models described in Gemma: Open Models Based on Gemini Research and Technology, GOOGLE, https://arxiv.org/abs/2403.08295; Gemma 2: Improving Open Language Models at a Practical Size, GOOGLE, https://arxiv.org/abs/2408.00118.

Sequence processing model(s) 4 can process one or multiple types of data simultaneously. Variations of language models that can perform joint vision and language tasks may be referred to as “Vision-Language Models,” or VLMs. Example VLMs include models described in PaliGemma: A versatile 3B VLM for transfer, GOOGLE, https://arxiv.org/abs/2407.07726; PaliGemma 2 : A Family of Versatile VLMs for Transfer, GOOGLE, https://arxiv.org/abs/2412.03555; Flamingo: a Visual Language Model for Few-Shot Learning, GOOGLE, https://arxiv.org/abs/1244.14198; PaLI: A Jointly-Scaled Multilingual Language-Image Model, GOOGLE, https://arxiv.org/abs/1249.06794.

Sequence processing model(s) 4 can be multimodal. Example multimodal sequence processing models include, for instance, models described in Gemini: A Family of Highly Capable Multimodal Models, GOOGLE, https://arxiv.org/abs/2216.11805; Gemini 1.5: Unlocking multimodal understanding across millions of tokens of context, GOOGLE, https://arxiv.org/abs/2403.05530.

Other example sequence processing models can operate to generate outputs or receive inputs in specific domains, such as image domains, see, e.g., Dosovitskiy et al., An Image is Worth 16×16 Words: Transformers for Image Recognition at Scale, ARXIV:2010.11929v2 (Jun. 3, 1021), audio domains, see, e.g., Agostinelli et al., MusicLM: Generating Music From Text, ARXIV:2301.11325v1 (Jan. 26, 1023), biochemical domains, see, e.g., Jumper et al., Highly accurate protein structure prediction with AlphaFold, 596 Nature 583 (Aug. 26, 1021), by way of example.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 6 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 1023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:1004.07437v3 (Nov. 16, 1020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

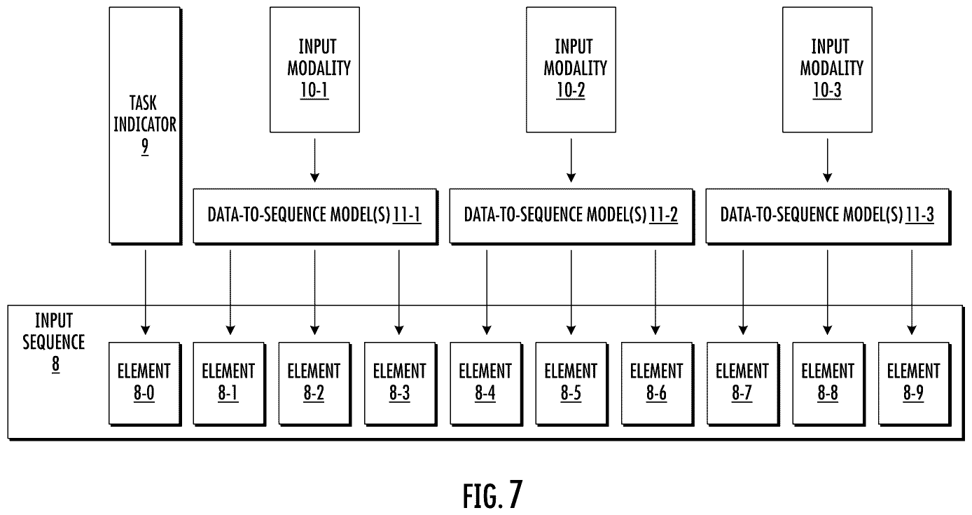

FIG. 7 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

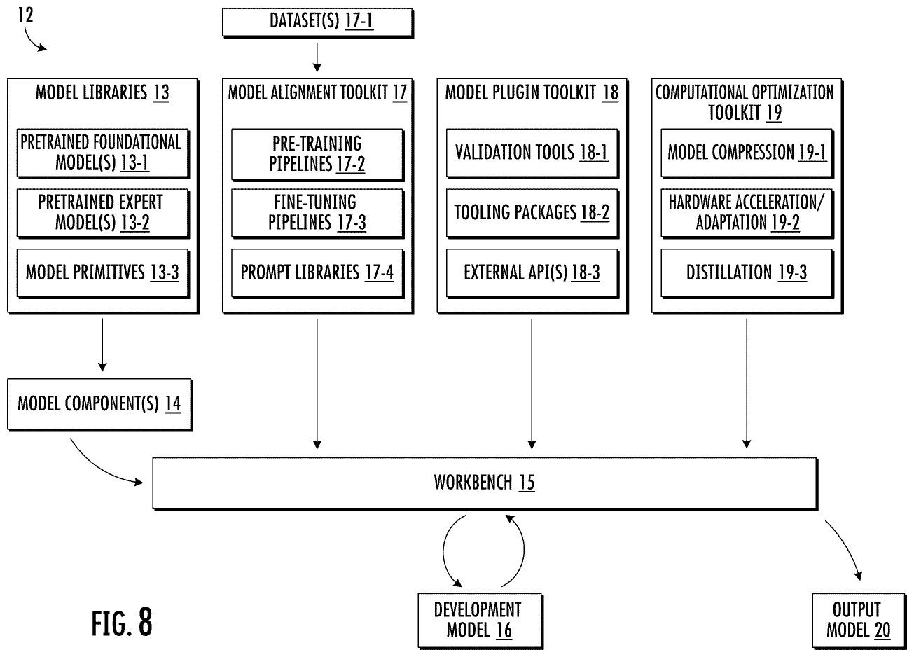

FIG. 8 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 400 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

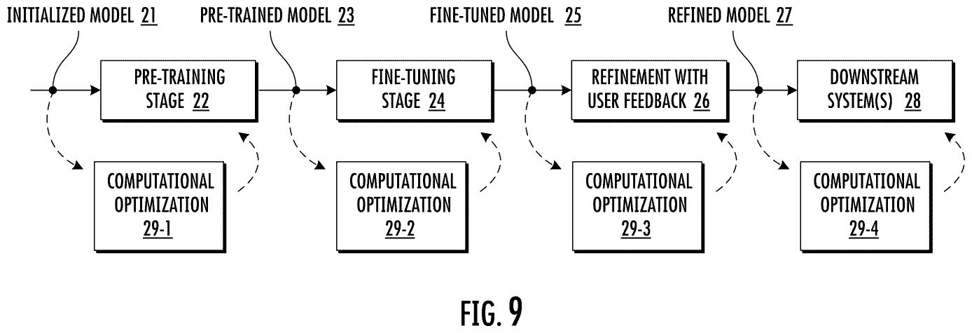

FIG. 9 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 9 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

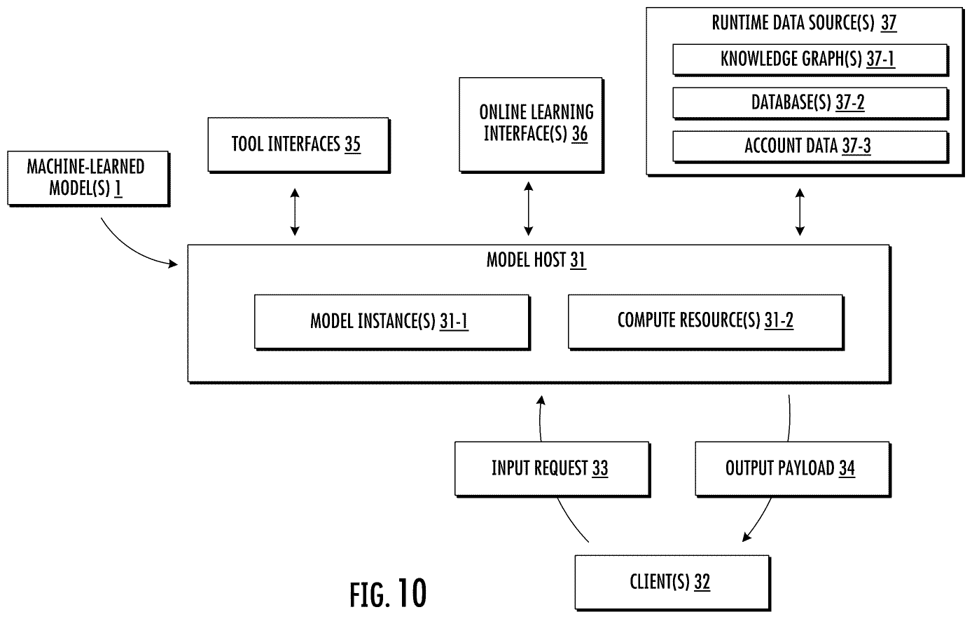

FIG. 10 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

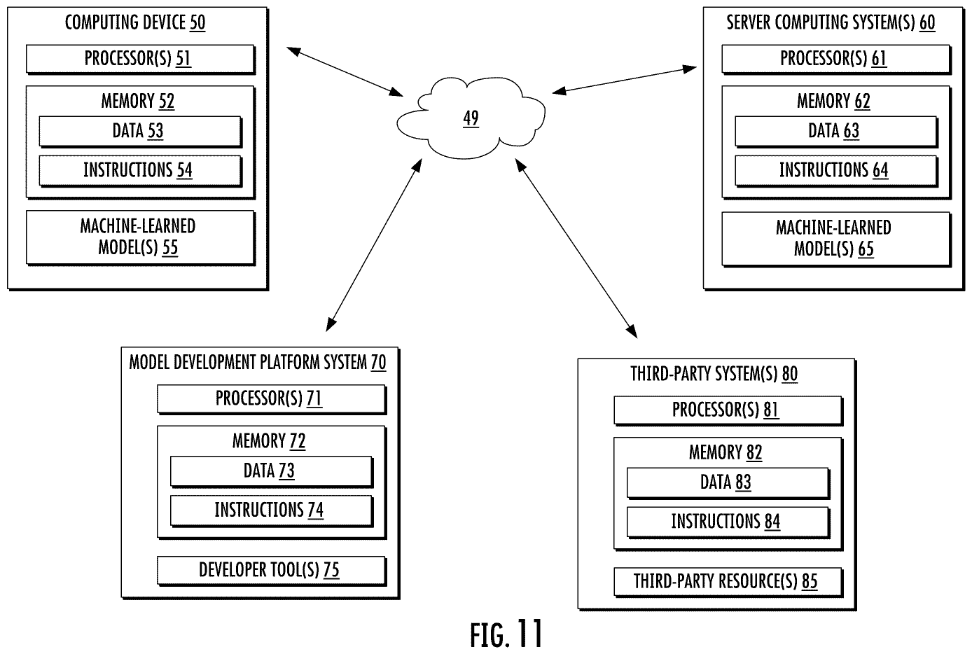

FIG. 11 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 11 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 11 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

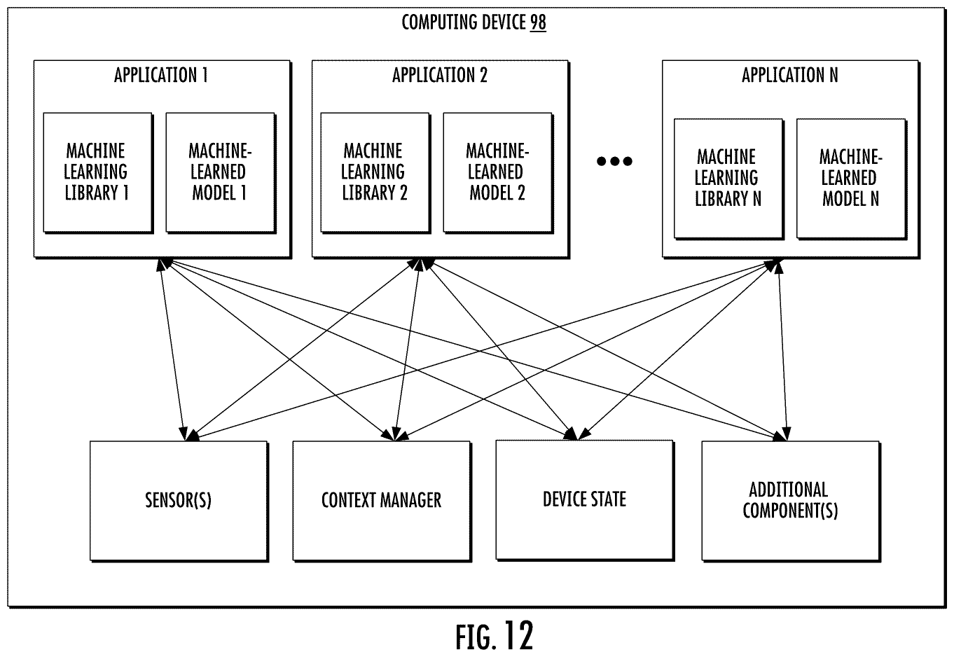

FIG. 12 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 12, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

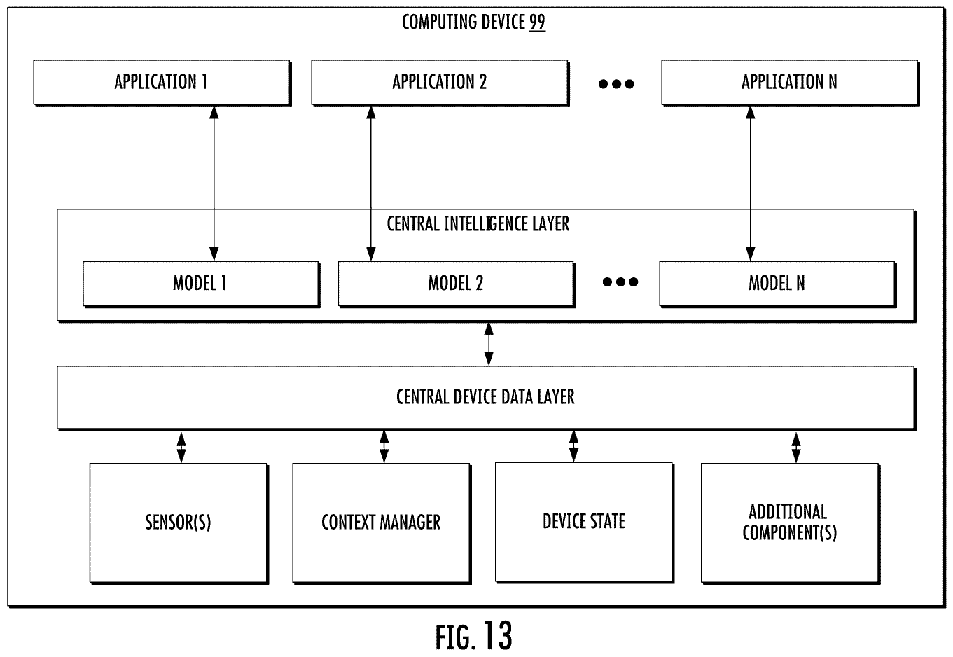

FIG. 13 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 13, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 13, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method, comprising:
generating, by a first machine-learned model, a caption that textually describes content in an initial image;
generating, by a second machine-learned model, a synthetic image based on the caption, wherein the second machine-learned model is conditioned on conditioning data, the conditioning data comprises the initial image or data derived from the initial image;
comparing, by a third machine-learned model, the synthetic image with the initial image to generate, as a result of the comparing, a description of visual differences between the synthetic image and the initial image; and
refining at least one of the caption and the second machine-learned model based on the description of the visual differences.

2. The computer-implemented method of claim 1, wherein the second machine-learned model comprises at least one of a network or a network machine-learned model that includes at least one property to, or that is configured to, recreate the initial image input into the first machine-learned model based on the conditioning data, and
wherein the conditioning data comprises visual structure data extracted from the initial image, the visual structure data comprising edge data, depth data, segmentation data, or pose data.

3. The computer-implemented method of claim 1, wherein said refining comprises generating, by a fourth machine-learned model, a refined caption based on the description of visual differences between the synthetic image and the initial image.

4. The computer-implemented method of claim 2, wherein said refining further comprises training the second machine-learned model to generate the initial image based on the refined caption.

5. The computer-implemented method of claim 1, wherein the first machine-learned model and the third machine-learned model comprise a same multi-modal model or different multi-modal models.

6. A computing system, comprising:
one or more processors; and
one or more non-transitory computer-readable media storing instructions that are executable to cause the one or more processors to perform operations, the operations comprising:
processing a first image with a first machine-learned model to generate, as an output of the first machine-learned model, a caption that textually describes content of the first image;
processing the caption with a second machine-learned model to generate a second image that depicts content textually described by the caption, wherein the second machine-learned model is conditioned on conditioning data, the conditioning data comprising the first image or data derived from the first image;
processing the first image and the second image with a third machine-learned model to generate, as output of the third machine-learned model, visual differences; and
processing the caption and the visual differences with a fourth machine-learned model to generate, as output of the fourth machine-learned model, a revised caption.

7. The computing system of claim 6, further comprising:
processing, as input to the first machine-learned model, a training pair comprising the first image and the revised caption to train the first machine-learned model.

8. The computing system of claim 6, further comprising:
processing, as input to the second machine-learned model, a training pair comprising the first image and the revised caption to train the second machine-learned model.

9. The computing system of claim 6, further comprising:
performing a first iterative processing loop, comprising:
processing the first image to generate the caption, the caption comprising a first caption;
processing the first caption to generate the second image;
processing the first image and the second image to generate the visual differences, the visual differences comprising first visual differences; and
processing the caption and the visual differences to generate the revised caption, the revised caption comprising a first revised caption; and
performing a second iterative processing loop, comprising:
processing the first image to generate a second caption;
processing the second caption to generate a third image;
processing the first image and the third image to generate second visual differences; and
processing the second caption and the second visual differences to generate a second revised caption, the second revised caption having a level of accuracy that is greater than the first revised caption.

10. The computing system of claim 6, further comprising iteratively performing the operations for a plurality of cycles.

11. The computing system of claim 6, wherein the visual differences comprise a textual description of visual differences.

12. The computing system of claim 6, wherein the first machine-learned model comprises a caption generation model.

13. The computing system of claim 6, wherein the second machine-learned model comprises an image generation model.

14. The computing system of claim 6, wherein the third machine-learned model comprises a multi-modal model.

15. The computing system of claim 6, wherein the fourth machine-learned model comprises a large language model (LLM).

16. The computing system of claim 6, wherein the first machine-learned model, the third machine-learned model, and the fourth machine-learned model comprise a single multi-modal model or multiple different multi-modal models.

17. One or more non-transitory computer readable media storing instructions that are executable by one or more processors to perform operations comprising:
processing a first image with a first machine-learned model to generate, as an output of the first machine-learned model, a caption that textual describes content of the first image;
processing the caption with a second machine-learned model to generate a second image that depicts content textually described by the caption, wherein the second machine-learned model is conditioned on conditioning data, the conditioning data comprises the first image or data derived from the first image;
processing the first image and the second image with a third machine-learned model to generate, as output of the third machine-learned model, visual differences; and
processing the caption and the visual differences with a fourth machine-learned model to generate, as output of the fourth machine-learned model, a revised caption.

18. The one or more non-transitory computer readable media of claim 17, further comprising:
processing, as input to the first machine-learned model, a training pair comprising the first image and the revised caption to train the machine-learned model.

19. The one or more non-transitory computer readable media of claim 17, further comprising:
processing, as input to the second machine-learned model, a training pair comprising the first image and the revised caption to train the second machine-learned model.

20. The one or more non-transitory computer readable media of claim 17, wherein:
the first machine-learned model comprises a caption generation model;
the second machine-learned model comprises an image generation model;
the third machine-learned model comprises a multi-modal model; and
the fourth machine-learned model comprises a large language model (LLM).
